(19) United States
(12) Patent Application Publication
(10) Pub. No.: US 2026/0253789 A1
(43) Pub. Date: Aug. 27, 2026

(54) COIL DEVICE

(71) Applicant: TDK Corporation, Tokyo (JP)

(72) Inventors: Yuichi OYANAGI, Tokyo (JP); Toru TONOGAI, Tokyo (JP)

(73) Assignee: TDK Corporation, Tokyo (JP)

(21) Appl. No.: 19/545,328

(22) Filed: Feb. 20, 2026

(30) Foreign Application Priority Data
Feb. 25, 2025 (JP) 2025-028321

(51) Int. Cl. H01F 27/28; H01F 27/32

(52) U.S. Cl. CPC H01F 27/2823; H01F 27/324

(57) ABSTRACT

A coil device includes a winding portion including a rectangular wire having a surface covered with an insulating layer and being wound edgewise. The rectangular wire of the winding portion includes an inner end close to a winding axis of the winding portion and an outer end opposite the inner end. The insulating layer includes an inner end portion at the inner end of the rectangular wire and an outer end portion at the outer end of the rectangular wire. The inner end portion of the insulating layer has a thickness larger than that of the outer end portion of the insulating layer in a cross section of the rectangular wire of the winding portion.

The present application claims a priority to Japanese patent application No. 2025-028321 filed on February 25, 2025, which is incorporated herein by reference in its entirety.

### BACKGROUND

The present disclosure relates to a coil device.

Known as a coil device used as an inductor or the like is a coil device disclosed in, for example, Patent Document 1. Such a coil device includes a coil of an edgewise wound rectangular wire disposed in a core and an insulating resin around the coil.

Such a coil device including a coil of an edgewise wound rectangular wire can be expected to have a high inductance and is in need of further improvement in characteristics.

Patent Document 1: JP Patent Application Laid Open No. 2004-39888

### SUMMARY

A coil device according to one aspect of the present disclosure includes

a winding portion including a rectangular wire having a surface covered with an insulating layer and being wound edgewise,

wherein

the rectangular wire of the winding portion includes an inner end close to a winding axis of the winding portion and an outer end opposite the inner end,

the insulating layer includes an inner end portion at the inner end of the rectangular wire and an outer end portion at the outer end of the rectangular wire, and

the inner end portion of the insulating layer has a thickness larger than that of the outer end portion of the insulating layer in a cross section of the rectangular wire of the winding portion.

### BRIEF DESCRIPTION OF THE DRAWING(S)

FIG. 1 is a perspective view of a coil device according to one embodiment.

FIG. 2 is a perspective view of the coil device shown in FIG. 1 viewed from a mounting surface side.

FIG. 3 is a sectional view of the coil device shown in FIG. 1 along a line III-III.

FIG. 4 is a partial enlarged view of the coil device shown in FIG. 3.

### DETAILED DESCRIPTION

Hereinafter, an embodiment of the present disclosure is described with reference to the drawings. Illustrations in the drawings are only schematically and exemplarily provided for understanding of the present disclosure; and the illustrated appearance, dimensional ratios, or the like may not be exactly the same as those of an actual device. The present disclosure is not limited to the following embodiment.

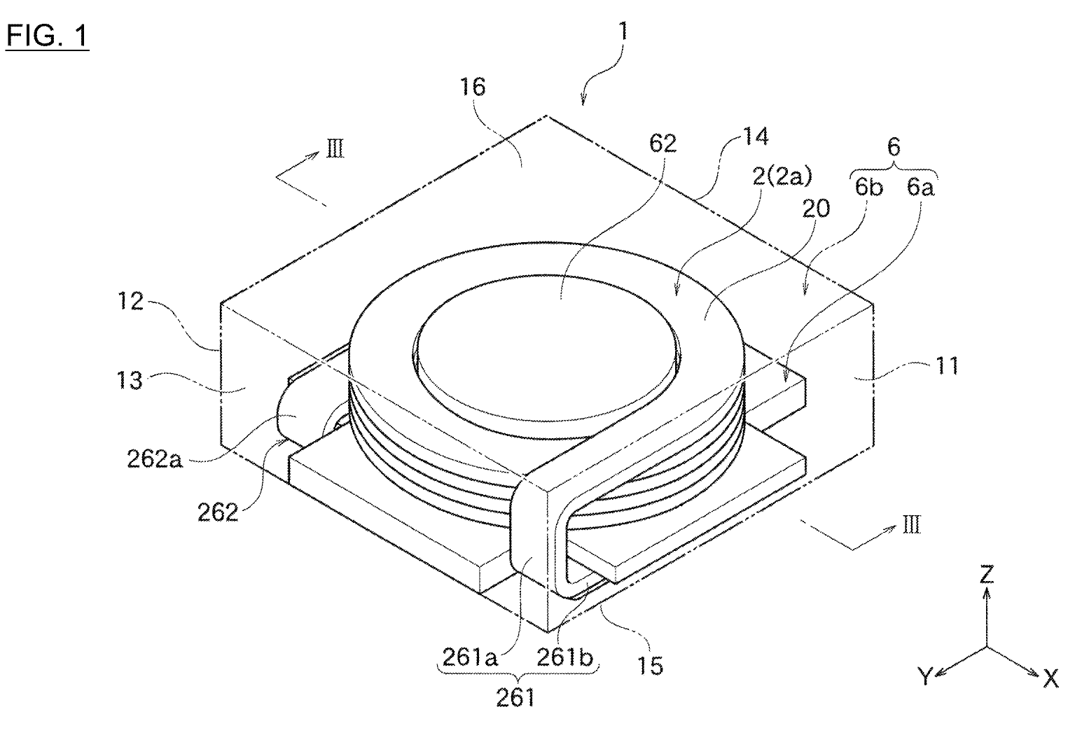

A coil device 1 of the present embodiment shown in FIG. 1 is a surface mounting type inductor and may be mounted on, for example, a power supply circuit of electronics. The coil device 1 may have any dimensions. The coil device 1 has, for example, a width of 1.0 to 7.0 mm in the X-axis direction, a length of 1.0 to 7.0 mm in the Y-axis direction, and a height of 0.5 to 5.0 mm in the Z-axis direction.

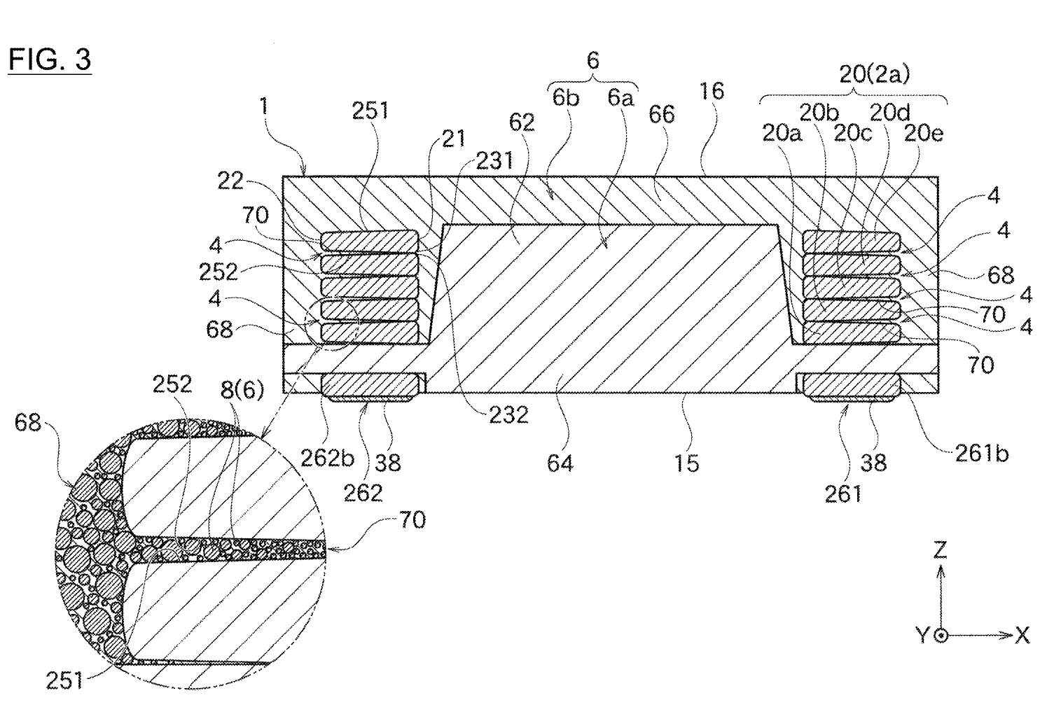

As shown in FIG. 1, the coil device 1 includes a coil 2, which is composed of a rectangular wire 2a having a surface covered with an insulating layer 30 (see FIG. 3), and a core 6, which has magnetism. In the coil device 1, at least a winding portion 20 of the coil 2 is embedded in the core 6.

The coil device 1 may have any shape. In the example shown in FIG. 1, the coil device 1 has a substantially rectangular parallelepiped shape and includes a first outer surface 11, a second outer surface 12, a third outer surface 13, a fourth outer surface 14, a fifth outer surface 15, and a sixth outer surface 16. The first outer surface 11 and the second outer surface 12 face each other in a first direction. The third outer surface 13 and the fourth outer surface 14 face each other in a second direction. The fifth outer surface 15 and the sixth outer surface 16 face each other in a third direction. The first direction, the second direction, and the third direction are orthogonal to each other.

In the drawings, the X-axis is an axis corresponding to the first direction; the Y-axis is an axis corresponding to the second direction; and the Z-axis is an axis corresponding to the third direction. The origin of the XYZ coordinate system is designated as a center of the core 6. The external shape of the coil device 1 is not limited to the substantially rectangular parallelepiped shape and may be other polyhedral shapes, such as an octahedral shape and a decahedral shape.

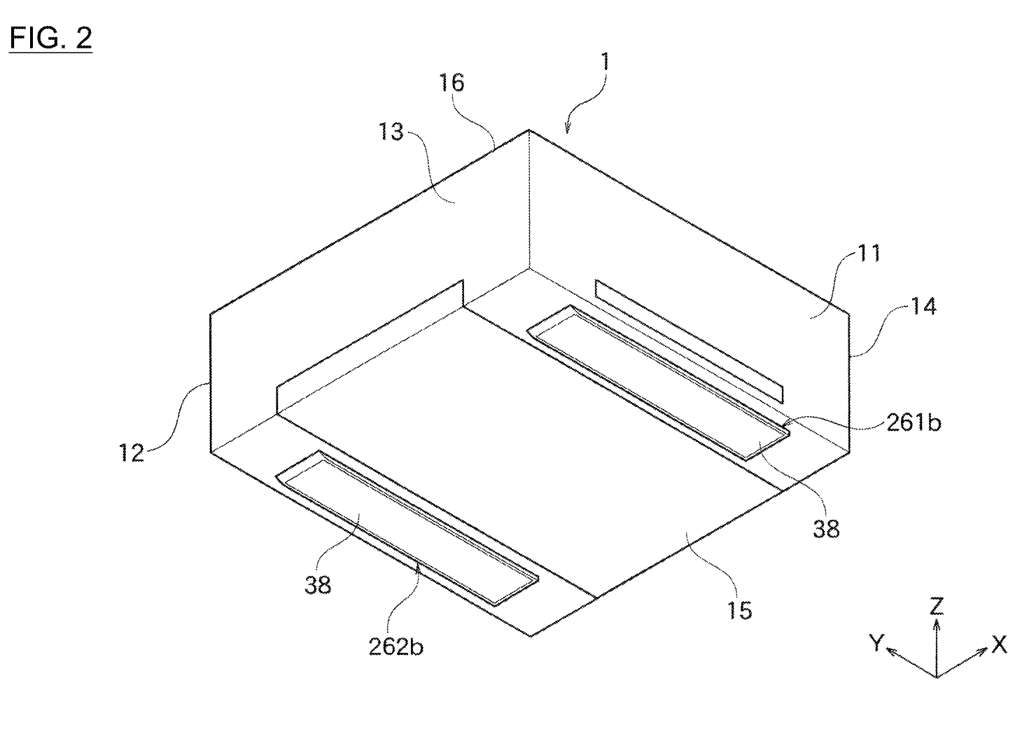

As shown in FIG. 1, the coil 2 is composed of the rectangular wire 2a and includes the winding portion 20, where the rectangular wire 2a is edgewise wound. The winding portion 20 is embedded in the core 6. The coil 2 further includes a pair of lead-out portions 261 and 262 drawn out from the winding portion 20. The lead-out portion 261 constitutes one end of the coil 2. The lead-out portion 262 constitutes an other end of the coil 2. As shown in FIG. 2, the lead-out portions 261 and 262 are partly exposed from the bottom surface (fifth outer surface 15) of the core 6.

FIG. 3 is a sectional view perpendicular to the Y-axis of the coil device 1. As shown in FIG. 3, the winding portion 20 is formed by winding the rectangular wire 2a edgewise by five turns and includes turn layers 20a to 20e. The turn layers 20a to 20e are overlappingly disposed in the Z-axis direction. However, the number of turns of the winding portion 20 is not limited provided that the winding portion 20 has at least one turn, i.e., the number of turn layers is one or more. Between the turn layers 20a to 20e may be a space 4. The core 6 may be partly in this space 4.

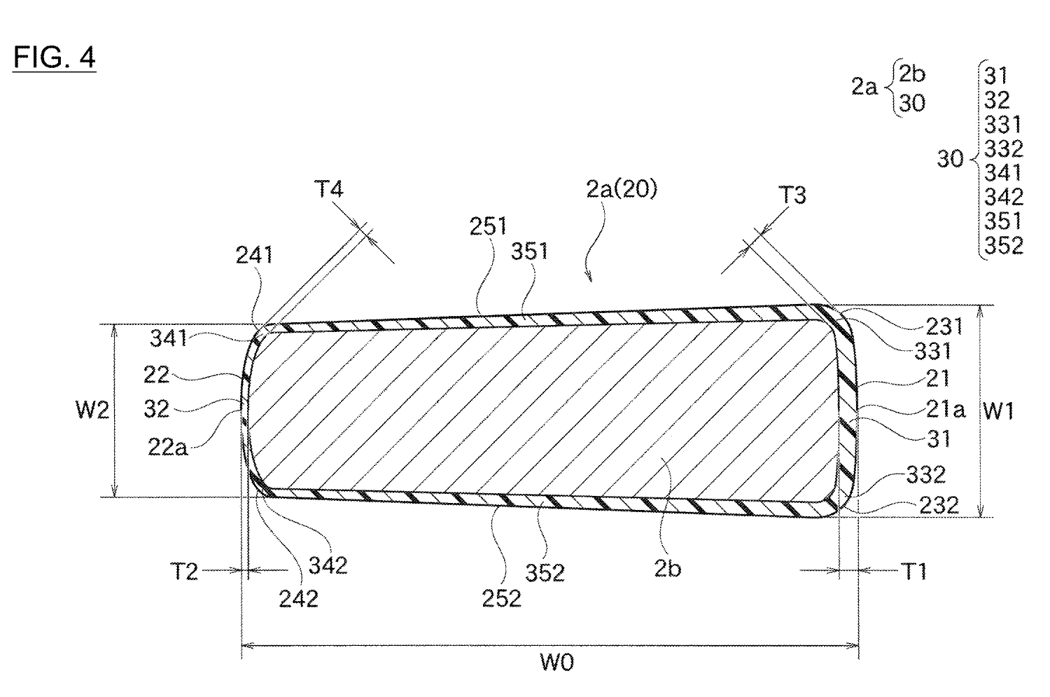

FIG. 4 is an enlarged view of the rectangular wire 2a of the winding portion 20 (each turn layer) shown in FIG. 3. As shown in FIG. 4, the rectangular wire 2a is composed of a wire whose surface is covered with the insulating layer 30. A conductor 2b constituting the rectangular wire 2a may be of any material. Copper, silver, an alloy containing these metals, or other metal or alloy is used. The insulating layer 30 is not limited. A known insulating film, such as a polyamide-imide resin, a polyurethane resin, or an epoxy acrylic resin, is used.

The rectangular wire 2a shown in FIG. 4 may have any width W0. The width W0 is, for example, 0.1 to 0.7 mm. Its thickness in the Z-axis direction is, for example, 0.05 to 0.5 mm. The rectangular wire 2a of the winding portion 20 includes an inner end 21 close to the winding axis and an outer end 22 far from the winding axis. In a cross section of the rectangular wire 2a of the winding portion 20, a thickness W1 of the inner end 21 is larger than a thickness W2 of the outer end 22. The rectangular wire 2a may have a substantially trapezoidal cross-sectional shape with a longer inner side and a shorter outer side. In the present specification, a cross section of the rectangular wire refers to a section perpendicular to a direction in which the rectangular wire extends. In the present embodiment, because the rectangular wire 2a of the winding portion 20 extends substantially on an XY plane, a cross section of the rectangular wire 2a refers to a section extending along the Z-axis direction. In FIG. 4, this cross section of the rectangular wire 2a is a section extending along the Z-axis and the X-axis. In the present embodiment, characteristics of a cross section of the rectangular wire 2a of the winding portion 20 may be common to any cross sections of the winding portion 20.

As shown in FIG. 4, at the winding portion 20, the insulating layer 30 may entirely cover the conductor 2b along a circumferential direction of the rectangular wire 2a. The insulating layer 30 may have any thickness. The thickness may be, for example, 1/50 to 1/10 of the thickness of the rectangular wire 2a in the Z-axis direction.

As shown in FIG. 4, the insulating layer 30 at the inner end 21 of the rectangular wire 2a includes an inner end portion 31 having a thickness T1 whereas the insulating layer 30 at the outer end 22 of the rectangular wire 2a includes an outer end portion 32 having a thickness T2. The thickness T1 may be larger than the thickness T2. That the thickness T1 of the inner end portion 31 of the insulating layer 30 being larger than the thickness T2 of the outer end portion 32 of the insulating layer 30 in this manner enables a short circuit to be prevented, because possible damage to the inner end 21 close to the winding axis of the winding portion is less likely to reach the conductor 2b. In contrast, because the outer end 22 is less likely to have damage that leads to a short circuit, a smaller thickness of the insulating layer at the outer end 22 than at the inner end 21 can sufficiently prevent a short circuit.

The inner end portion 31 of the insulating layer 30 may be a region including an innermost end 21a, closest to the winding axis, of the rectangular wire 2a. The inner end portion 31 may connect inner corner portions 331 and 332 of the insulating layer 30. The inner corner portions 331 and 332 constitute inner corners 231 and 232 of the rectangular wire 2a described later. The thickness T1 may be even at the inner end portion 31 but may be partially smaller or larger. In the present embodiment, the thickness T1 of the inner end portion 31 of the insulating layer 30 is largest at the innermost end 21a. This thickness, at the innermost end 21a, of the inner end portion 31 can be deemed to be the thickness T1 of the inner end portion 31 of the insulating layer 30.

The outer end portion 32 of the insulating layer 30 may be a region including an outermost end 22a, farthest from the winding axis, of the rectangular wire 2a. The outer end portion 32 may connect outer corner portions 341 and 342 of the insulating layer 30. The outer corner portions 341 and 342 constitute outer corners 241 and 242 of the rectangular wire 2a described later. The thickness T2 may be even at the outer end portion 32 but may be partially smaller or larger. In the present embodiment, the thickness T2 of the outer end portion 32 of the insulating layer 30 is largest at the outermost end 22a. This thickness, at the outermost end 22a, of the outer end portion 32 can be deemed to be the thickness T2 of the outer end portion 32 of the insulating layer 30.

The thickness T1 of the inner end portion 31 of the insulating layer 30 is not limited provided that the thickness T1 is larger than the thickness T2 of the outer end portion 32 of the insulating layer 30. The thickness T1 of the inner end portion 31 of the insulating layer 30 may be, for example, 1.2 to 3 times the thickness T2 of the outer end portion 32 of the insulating layer 30.

As shown in FIG. 4, the inner corner portions 331 and 332 of the insulating layer 30, which constitute the inner corners 231 and 232 of the rectangular wire 2a, have a thickness T3 whereas the outer corner portions 341 and 342 of the insulating layer 30, which constitute the outer corners 241 and 242 of the rectangular wire 2a, have a thickness T4. The thickness T3 may be larger than the thickness T4. The thickness T3 of the inner corner portion 33 of the insulating layer 30 may be, for example, 1.2 to 3 times the thickness T4 of the outer corner portion 34 of the insulating layer 30. In the present specification, corners of the rectangular wire refer to vertices of a quadrilateral that is inscribed within an outer circumferential surface of the rectangular wire and has a largest possible area in a cross section of the rectangular wire. In the present embodiment, among the vertices of a largest quadrilateral inscribed within the outer circumferential surface of the rectangular wire 2a, two vertices close to the winding axis are referred to as the inner corners 231 and 232 whereas the other two vertices far from the winding axis are referred to as the outer corners 241 and 242. The inner corners 231 and 232 are hereinafter referred to as inner corner 23. The inner corner portions 331 and 332 of the insulating layer 30 are referred to as inner corner portion 33. The outer corners 241 and 242 are referred to as outer corner 24. The outer corner portions 341 and 342 are referred to as outer corner portion 34.

Between the inner corner 231 and the outer corner 241 of the rectangular wire 2a is an intermediate portion 251. An intermediate part 351 of the insulating layer 30 is located at the intermediate portion 251. The intermediate part 351 becomes thicker from the outer corner portion 341 to the inner corner portion 331. Between the inner corner 232 and the outer corner 242 of the rectangular wire 2a is an intermediate portion 252. An intermediate part 352 of the insulating layer 30 is located at the intermediate portion 252. The intermediate part 352 becomes thicker from the outer corner portion 342 to the inner corner portion 332. The intermediate portions 251 and 252 are hereinafter referred to as intermediate portion 25. The intermediate parts 351 and 352 of the insulating layer 30 are referred to as intermediate part 35.

As shown in FIG. 1, the lead-out portion 261 may include a terminal portion 261b connectable to a mounting substrate or the like and a connecting portion 261a connecting the winding portion 20 and the terminal portion 261b. As shown in FIG. 1, the connecting portion 261a of the lead-out portion 261 may connect the uppermost turn of the winding portion 20 in the Z-axis direction (in the present embodiment, the turn layer 20e shown in FIG. 3) and the terminal portion 261b. As shown in FIG. 3, the terminal portion 261b may partly be exposed below a bottom portion 64 of the core 6.

As shown in FIG. 1, the lead-out portion 262 may include a terminal portion 262b (see FIG. 2) connectable to a mounting substrate or the like and a connecting portion 262a connecting the winding portion 20 and the terminal portion 262b. As shown in FIG. 1, the connecting portion 262a of the lead-out portion 262 may connect the lowermost turn of the winding portion 20 in the Z-axis direction (in the present embodiment, the turn layer 20a shown in FIG. 3) and the terminal portion 262b (see FIG. 2). As shown in FIG. 3, the terminal portion 262b may partly be exposed below the bottom portion 64 of the core 6.

Parts of the terminal portions 261b and 262b exposed below the bottom surface of the core 6 have the above insulating layer 30 removed and may be provided with a connectable layer 38 electrically connectable to a wiring substrate or the like. The connectable layer 38 is a portion that is connectable to the wiring substrate or the like. Thus, the connectable layer 38 has solder wettability and plays a role in supporting connection between the terminal portions 261b and 262b and the mounting substrate. The connectable layer 38 may have, for example, a plating film. Examples of the plating film include metals (e.g., Sn, Au, Ni, Pt, Ag, and Pd) and their alloys. Methods including sputtering or the like may be used to form the connectable layer 38. The connectable layer 38 has a thickness smaller than that of the terminal portions 261b and 262b. The thickness of the connectable layer 38 may be, for example, 3 to 30 µm.

As shown in FIGS. 1 and 2, the core 6 may cover the coil 2 except for part of the terminal portions 261b and 262b. The core 6 may be composed of a material including a magnetic body and a resin. Examples of the magnetic body of the core 6 include ceramic magnetic bodies and metal magnetic bodies.

Examples of ceramic magnetic bodies of the core 6 include ferrites, such as Ni-Zn based ferrites and Mn-Zn based ferrites. Examples of metal magnetic bodies of the core 6 are not limited and include Fe-Ni alloys, Fe-Si alloys, Fe-Si-Cr alloys, Fe-Co alloys, Fe-Si-Al alloys, and amorphous iron. In terms of preventing short circuits and improving product properties, these magnetic bodies may be insulation coated magnetic particles including a magnetic body covered with an insulating film or may be insulation coated metal particles. The insulating film covering a magnetic particle may be an oxide film or an insulation coating film (e.g., glass or resin).

The magnetic body of the core 6 may include multiple types of particles with different particle sizes in terms of being sufficient in amount. The resin of the core 6 is not limited. Examples of the resin include an epoxy resin, a phenol resin, a polyester resin, a polyurethane resin, a polyimide resin, other synthetic resins, and other non-magnetic materials. The core 6 may be a sintered body of metal magnetic particles.

As shown in FIG. 3, the core 6 may include a columnar portion 62 disposed in the winding portion 20 of the coil, the bottom portion 64 disposed below the winding portion 20, an upper portion 66 covering the winding portion 20 from above, and a side portion 68 covering an outer side of the winding portion 20, in brief. The core 6 may be compaction molded using the above materials; however, in terms of simplifying assembly, the core 6 may be provided by combining a base portion 6a, which includes the columnar portion 62 and the bottom portion 64 molded in advance, and an exterior body 6b, which fills spaces between the coil and the base portion and constitutes portions other than the columnar portion 62 and the bottom portion 64.

The columnar portion 62 may have a height not reaching above the winding portion 20 but may penetrate the winding portion 20 along the winding axis. With the core 6 including the columnar portion 62 inside, the coil device 1 is easily assembled, and a product can be prevented from having a short circuit. The base portion 6a and the exterior body 6b of the core 6 may be molded using the same material or different materials.

As shown in FIG. 3, there may be a filler 70 of the side portion 68 of the core 6 in the space 4 between the intermediate portion 251 of a turn layer and the intermediate portion 252 of the turn layer adjacently above the former turn layer in the Z-axis direction. The filler 70 may completely fill the space 4 but may partly leave a blank. The adjacent turn layers are in contact with each other at the inner corners 231 and 232 in FIG. 3 but may be away from each other. In a situation where the adjacent turn layers are away from each other, the space 4 may continue from an outer side to an inner side along the intermediate portion 251 or 252. In this situation, the filler 70 may be disposed from an outer side to an inner side of the space 4.

The coil device 1 of the present embodiment can be manufactured, for example, as follows. First, the base portion 6a, which includes the columnar portion 62 and the bottom portion 64 molded in advance, shown in FIG. 1 is prepared. The rectangular wire 2a whose surface is covered with the above insulating layer 30 is wound edgewise to form the air core coil. In the winding portion 20 of this coil 2, the columnar portion 62 is disposed. The coil 2 is attached to the base portion 6a so that the terminal portion 261b of the lead-out portion 261 and the terminal portion 262b of the lead-out portion 262 are disposed below the bottom portion 64.

Then, the resultant assembly including the coil 2 and the base portion 6a is disposed in a cavity of a predetermined mold. This assembly is arranged so that the terminal portion 261b of the lead-out portion 261 and the terminal portion 262b of the lead-out portion 262 are partly exposed. Around the assembly, the exterior body 6b is insert injection molded. As a constituent material of the exterior body 6b, a material having fluidity at the time of molding is used. A complex magnetic material including a thermoplastic resin or a thermosetting resin as a binder may be used. As described above, the core 6 may also, as a whole, be compaction molded.

As described above, according to research by the present inventors, damage to the insulating layer near the winding axis of the winding portion of the coil of the edgewise wound rectangular wire whose surface is covered with the insulating layer may cause a short circuit of a product. As shown in FIG. 4, in a cross section of the rectangular wire 2a of the winding portion 20 of the coil device 1 of the present embodiment, the thickness T1 of the inner end portion 31 of the insulating layer 30 at the inner end 21 of the rectangular wire 2a close to the winding axis of the winding portion 20 is larger than the thickness T2 of the outer end portion 32 of the insulating layer 30 at the outer end 22 opposite the inner end 21 of the rectangular wire 2a. Thus, the coil device 1 of the present embodiment can sufficiently prevent a short circuit. Because thinning the outer end portion 32 of the insulating layer 30 at the outer end 22 of the rectangular wire 2a enables the core 6 to be sufficient in amount, product properties improve as well.

As shown in FIG. 3, the winding portion 20 may include the turn layers 20a to 20e. These turn layers 20a to 20e may have a thickness such that the thickness T1 of the inner end portion 31 of the insulating layer 30 is larger than the thickness T2 of the outer end portion 32 of the insulating layer 30. Such a coil device can further improve product properties.

As shown in FIG. 4, the thickness T3 of the inner corner portion 33 of the insulating layer 30, which constitutes the inner corner 23 of the rectangular wire 2a, may be larger than the thickness T4 of the outer corner portion 34 of the insulating layer 30, which constitutes the outer corner 24 of the rectangular wire 2a. Because a short circuit of a product easily occurs at the inner corner 23 of the rectangular wire, increasing the thickness T3 of the inner corner portion 33 of the insulating layer can improve product reliability.

As shown in FIG. 4, the insulating layer 30 may include the intermediate part 35 thickening from the outer corner portion 34 to the inner corner portion 33. The rectangular wire 2a may have a thickness such that the thickness W1 of the inner end is larger than the thickness W2 of the outer end. A substantially trapezoidal sectional shape of the rectangular wire 2a with a thinner outer side and a thicker inner side enables, as shown in FIG. 3, some of insulation coated particles 8 included in the core 6 to easily enter the space 4 between the turn layers. This enables the core 6 to be larger in amount, improving product properties. Such a structure of the coil device 1 of the present embodiment can also prevent a short circuit of a product.

The present disclosure is not limited to the above embodiment and can be variously modified to the extent that technical problems do not arise or the scope of the present disclosure is not exceeded.

In the present disclosure, the coil device 1 has an external shape such as a polyhedral shape (e.g., rectangular parallelepiped shape); however, the external shape of the coil device 1 is not limited to a polyhedral shape and may be a columnar shape (e.g., a cylindrical shape or an elliptic cylinder shape) in terms of ensuring effective magnetic flux.

### Additional Note 1

A coil device including

a winding portion including a rectangular wire having a surface covered with an insulating layer and being wound edgewise,

in which

the rectangular wire of the winding portion includes an inner end close to a winding axis of the winding portion and an outer end opposite the inner end,

the insulating layer includes an inner end portion at the inner end of the rectangular wire and an outer end portion at the outer end of the rectangular wire, and

the inner end portion of the insulating layer has a thickness larger than that of the outer end portion of the insulating layer in a cross section of the rectangular wire of the winding portion.

### Additional Note 2

The coil device according to additional note 1, in which

the rectangular wire includes an inner corner and an outer corner,

the inner corner includes an inner corner portion of the insulating layer,

the outer corner includes an outer corner portion of the insulating layer, and

the inner corner portion of the insulating layer has a thickness larger than that of the outer corner portion of the insulating layer.

### Additional Note 3

The coil device according to additional note 2, in which the insulating layer includes an intermediate portion thickening from the outer corner portion to the inner corner portion.

### Additional Note 4

The coil device according to additional note 1, in which the rectangular wire has a thickness such that the inner end is thicker than the outer end.

### Additional Note 5

The coil device according to additional note 1, in which

the winding portion includes turn layers, and

the turn layers have a thickness such that the inner end portion of the insulating layer is thicker than the outer end portion of the insulating layer.

### Additional Note 6

The coil device according to additional note 5, in which some of insulation coated particles included in the core are in between the turn layers.

### Additional Note 7

The coil device according to additional note 1, in which the core includes a columnar portion penetrating the winding portion along the winding axis inside.

### Additional Note 8

The coil device according to additional note 7, in which the core includes insulation coated metal particles.

### REFERENCE NUMERALS

1... coil device

11... first outer surface

12... second outer surface

13... third outer surface

14... fourth outer surface

15... fifth outer surface

16... sixth outer surface

2... coil

2a... rectangular wire

2b... conductor

20... winding portion

20a to 20e... turn layer

21... inner end

21a... innermost end

22... outer end

22a... outermost end

23 (231, 232)... inner corner

24 (241, 242)... outer corner

25 (251, 252)... intermediate portion

261, 262... lead-out portion

261a, 262a... connecting portion

261b, 262b... terminal portion

30... insulating layer

31... inner end portion

32... outer end portion

33 (331, 332)... inner corner portion

34 (341, 342)... outer corner portion

35 (351, 352)... intermediate part

38... connectable layer

4... space

6... core

6a... base portion

6b... exterior body

62... columnar portion

64... bottom portion

66... upper portion

68... side portion

70... filler

8... insulation coated metal particle

What is claimed is:

1. A coil device comprising:
a winding portion comprising a rectangular wire having a surface covered with an insulating layer and being wound edgewise,
wherein
the rectangular wire of the winding portion comprises an inner end close to a winding axis of the winding portion and an outer end opposite the inner end,
the insulating layer comprises an inner end portion at the inner end of the rectangular wire and an outer end portion at the outer end of the rectangular wire, and
the inner end portion of the insulating layer has a thickness larger than that of the outer end portion of the insulating layer in a cross section of the rectangular wire of the winding portion.

2. The coil device according to claim 1, wherein
the rectangular wire comprises an inner corner and an outer corner,
the inner corner comprises an inner corner portion of the insulating layer,
the outer corner comprises an outer corner portion of the insulating layer, and
the inner corner portion of the insulating layer has a thickness larger than that of the outer corner portion of the insulating layer.

3. The coil device according to claim 2, wherein the insulating layer comprises an intermediate portion thickening from the outer corner portion to the inner corner portion.

4. The coil device according to claim 1, wherein the rectangular wire has a thickness such that the inner end is thicker than the outer end.

5. The coil device according to claim 1, wherein
the winding portion comprises turn layers, and
the turn layers have a thickness such that the inner end portion of the insulating layer is thicker than the outer end portion of the insulating layer.

6. The coil device according to claim 5, wherein some of insulation coated particles included in the core are in between the turn layers.

7. The coil device according to claim 1, wherein the core comprises a columnar portion penetrating the winding portion along the winding axis inside.

8. The coil device according to claim 7, wherein the core comprises insulation coated metal particles.
